(19) United States
(12) Patent Application Publication
(10) Pub. No.: US 2022/0258528 A1
(43) Pub. Date: Aug. 18, 2022

(54) VEGETABLE COMPONENTS, DEHYDRATED, SEALED AND WATERPROOFED, APPLIED FOR DECORATIVE PURPOSE ON GARMENTS, OBJECTS AND FURNISHING COMPONENTS AND ITS METHOD OF IMPLEMENTATION/MANUFACTURING PROCEDURES

(71) Applicant: Alfonso TADDEO, Airola (IT)

(72) Inventor: Alfonso TADDEO, Airola (IT)

(21) Appl. No.: 17/630,567

(22) PCT Filed: Jul. 27, 2020
(86) PCT No.: PCT/IT2020/050185

§ 371 Date: Jan. 27, 2022

(30) Foreign Application Priority Data
Jul. 30, 2019 (IT) 102019000013296

(51) Int. Cl. B44C 5/06; D06Q 1/12; B44C 5/00; B44C 1/10

(52) U.S. Cl. CPC B44C 5/06; B44C 1/105; B44C 5/005; D06Q 1/12

(57) ABSTRACT

The present invention relates to a vegetable components, dehydrated, sealed and waterproofed, applied for decorative purpose on garments, objects and furnishing components and its method of implementation.

### TECHNICAL FIELD OF THE INVENTION

The present invention relates to a vegetable component having a flat and thin structure, such as for example, a flower, a petal, the exocarp of a fruit or a leaf, which, by its method of implementation/manufacturing procedures which is also the subject of this invention, is provided with a waterproofing and protective coating which reacts positively even when subjected to washing, stress from contact and bending, being able to be applied on articles destined to the fashion world, furnishings and objects.

Therefore the present invention refers:

a) to the product—that is to the vegetable component, for example a leaf of hemp (1)—treated through various Phases and equipped with a waterproof sealing coating that also allows the washing;

b) to the corresponding method of implementation/manufacturing procedures as composed by the following Phases: Phase 1—harvesting of the vegetable component; 2—washing and polishing; Phase 3—drying and ironing; Phase 4—stabilizing and conservative pressing; Phase 5—Vacuum coating and sealing with waterproofing and protective film; Phase 6—Application on the surface of the article to be decorated.

Phase 1—the vegetable component is chosen considering certain characteristics, when their manifestation is at the top, and therefore collected at the stage where it most respects them; the characteristics required are:
structural integrity: the vegetable component must not damage its structure, such as missing parts, cuts etc., either to satisfy the aesthetic function or to allow greater ease in the processing.
flexibility: the vegetable component shall be flexible, shall not have woody parts to prevent it from breaking when subjected to bending stress.
subtlety: the vegetable component must have a thin thickness so as to allow it to be coated, becoming one with the layers of film between which it is interposed, without the formation of air bubbles around its perimeter.

Phase 2:—the vegetable component is then cleaned by a jet of air to remove dust and external organisms from the surface and polished with a cloth, which does not release any residue of its material, moistened with distilled water to prevent staining caused by limestone residues in the water itself;

Phase 3—the vegetable component is placed inside a hot press, among those easily available on the market and used in the textile sector, which, in addition to fulfilling the function of dehydration of the vegetable component, simultaneously performs the function of ironing. The hot press (2) has two plates of which one, the upper (3), is covered with a sheet of paper (4), the other, the lower (5), is covered by a felt cloth (6) the thickness of 3 mm on which the vegetable component is placed so that, exerting pressure combined with the action carried out by the heat, the water contained by the vegetable component can be released and retained by the cloth; different units of vegetable components can be machined during each pressing process, covering the entire surface of the hot press plates, but avoiding overlapping.

Phase 4—the vegetable component dehydrated and stretched in the previous Phase 3, is again pressed, this time cold, placing it between layers of paper smooth (7) subjected to pressure by the use of a press (8) means any device or device capable of compressing a material placed between two floors, either fixed or movable or both; This Phase makes it possible to complete the process of dehydration of the vegetable component by absorbing any water residues still present in it, and also acts as a conservation system of the vegetable component, allowing a different number of units to be processed simultaneously so as to be able to be used also in industrial productions and not only in craft.

Phase 5—the vegetable component is interposed between two layers of thermo-adhesive polyurethane film positioned with the liner (9a-10a), that is a support of the film, towards the external and the thermoadhesive (9b-10b) the side of the film containing the heat-activated adhesive, to the interior so as to come into contact with the surface of the vegetable component in order to seal it to protect it from external physical agents with which it could come into contact. The film placed on the lower side (10a-10b), which will later adhere to the surface of the article to be decorated during phase 6, can have both a transparent finish and a covering finish of any colour, while the film placed on the upper side (9a-9b) must be transparent so as to make visible the vegetable component it covers. The adhesion between the two layers of film and the vegetable component placed between them takes place through the use of the hot press (2) and immediately after passing a rubber roller manually (11a) or a cold rolling machine (11b) may be used instead of the roller by sliding the vegetable component between the rollers of the vegetable; both operations are carried out on one side and on the other side of the vegetable component, finalizing the adhesion and sealing process obtained by means of thermal adhesive film.

Phase 6—the now coated vegetable component can be applied to the surface of the article to be decorated by the use of a adhesive, which may vary according to the material on which it is to be adhered; the most suitable is a thermo-adhesive in film format; proceed by removing the liner (10a) of the film placed on the underside of the coated vegetable component, and adhere to it the layer of thermoadhesive (12) by repeating the operations referred to above, i.e., hot pressing and rubber roller passage; then remove the excess part of the film that incorporates it, cutting it out according to the shape of the vegetable component or a shape you want more, but keeping the covering of a few millimetres protruding around the perimeter of the vegetable component in order to protect it also in its peripheral zones so that it is well sealed by the protective coating.

The coated vegetable component is applied to the article to be decorated (13) using the hot press (2); finally the liner (9a) of the film placed on the upper side is removed.

An alternative method to the use of glue, to make the vegetable component adhere to the surface of the article to be decorated, is a perimeter seam executed at the edges of the coating, avoiding to puncture the vegetal component covered, after removing both liners (9a-10a) and after removing the excess of the film as shown above. Seam and use of adhesive can also be matched.

Another method of application is the creation of a coat of arms, that is, the coated vegetable component is applied on a fabric support (having a form of choice) by glue and/or seam (as described above) which in turn is applied to the surface of the article to be always decorated by glue and/or sewing.

### BACKGROUND ART

As it is known to the state of the art, vegetable components (flowers, leaves, petals, fruit exocarp, etc.) for decorative purposes, on the surface of fashion articles, objects and furnishing components, meet limits due to the yield in terms of resistance and duration, where articles are subjected to shocks or stress as well as washing.

State of the art processes, such as decoupage, allow vegetable material to be applied to any surface using a mixture of water and glue, but this technique is not effective for articles to be washed; other known techniques involve the use of transparent resins which are shown as coatings having a thickness not thin and a rigid, inflexible and heavy consistency, not responding to market requirements with respect to the standards of comfort required by the textile market instead characterized by a certain flexibility, softness, lightness and subtlety; Moreover, these techniques are complicated in the processing making the result approximate also from the aesthetic as well as functional point of view. Moreover, the application methods already known do not allow the vegetable component, which tends to change over time in terms of shape, size and colour, to be applied preserving the same structure of origin, presenting itself to the eye with a not entirely natural look.

Moreover, the methods of application known to the state of the art require long and unsuitable timescales to market laws on production costs and times; considering the various stages in which they are articulated, in order to allow the vegetable component to be applied to the surface of the articles to be decorated, time is needed ranging from 2/3 days to 6/7 days (depending on the application methods used).

The solutions known up to now, in fact, provide for methods of application in which the vegetable component is subjected to processes which require drying in dark environments, then stored until actual application in containers inside which chemicals are placed and, when it is to be used, the vegetable component is usually placed on the affected surface and covered with resin material or transparent film so as to seal it inside the affected surface.

However, the methods of application known can not be defined as suitable methods for industrial production but more so for small artisanal productions which allow the realization of a few products at a time.

### DISCLOSURE OF INVENTION

The purpose of this invention is to solve or at least partially remedy the problems which characterise such methods known to the State of the art.

The purpose of this invention is to obtain a vegetable component to be applied for decorative purposes on the surfaces of articles intended for the world of fashion, design, furnishing and objects, equipping it with a waterproofing coating that also allows its washing without causing the decomposition of the vegetable component itself.

The purpose of this invention is to equip the vegetable component with a coating which is present as soft, thin, flexible and lightweight in order to meet the standards required by the market of clothing, objects and furnishings.

The purpose of this invention is to carry out a method for decorative application, of vegetable components on materials of various kinds, allowing the vegetable component to maintain its original structure by presenting itself to the eye with a completely natural look, reflecting its shape and colour, maintaining these characteristics also after its washing and ensuring repeated use over time.

The purpose of this invention is to realize a method for the application, for decorative purposes, of vegetable components on fashion articles, furnishings and objects, whose working can be carried out from the beginning to the end in the short period of time (1-2 hours of work) is divided into independent phases, allowing a subjective organization of the timing.

Another purpose of this invention is to make a product, namely the vegetable component with a sealing and protective coating, which is also the subject of this invention and the which can be produced in large quantities, preserved for a long time, transported from one place to another and, more generally, suitable to be used also in an industrial production.

### BRIEF DESCRIPTION OF DRAWINGS

Further characteristics and advantages of this invention will be clarified by the indicative and not restrictive description of a first form of product realized by the relevant method, which sees a leaf of hemp applied on a t-shirt for decorative purpose. For simplicity, the following description of the phases that make up the method (Phase 1 to Phase 6), as described above, allowing the application hemp leaf on a fabric surface, will be defined Method; the vegetable component used in this case, therefore the hemp leaf (1), will be called only Leaf.

FIG. 1—shows Phase 3 “drying and ironing”. The figure consists of two images:

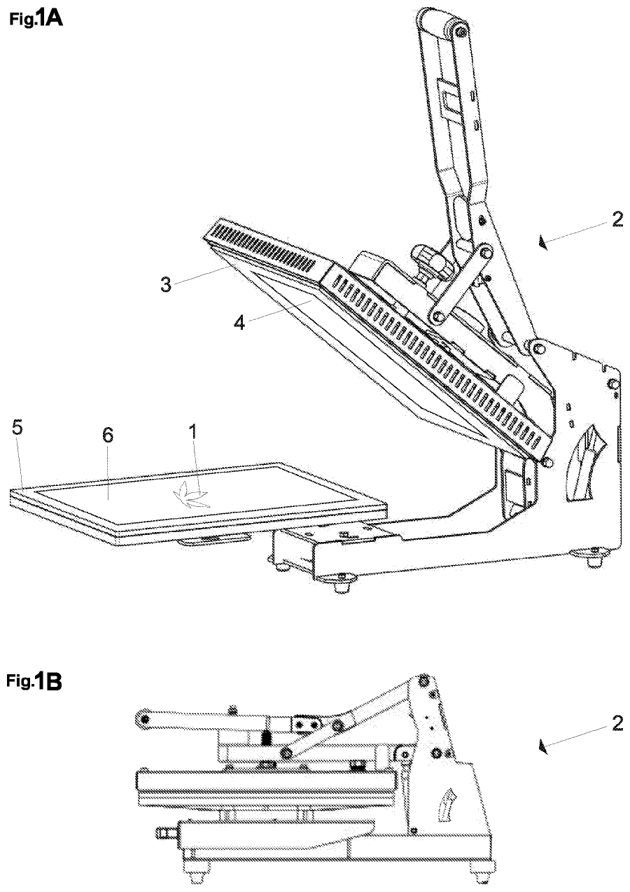

The image 1A shows the Leaf (1), which is placed—after being collected, washed and polished—inside a hot press (2) consisting of two plates, the upper one (3) covered by a sheet of paper (4) and the lower one (5) covered with a felt cloth (6); the image 1B shows the hot press (2) in operation.

FIG. 2—shows Phase 4 “stabilizer and conservative pressing”. The figure is composed of two images: the image 2A shows that the dehydrated Leaf (1) is interposed between sheets of paper (7) inside a press (8); the image 2B shows the press (8) in operation.

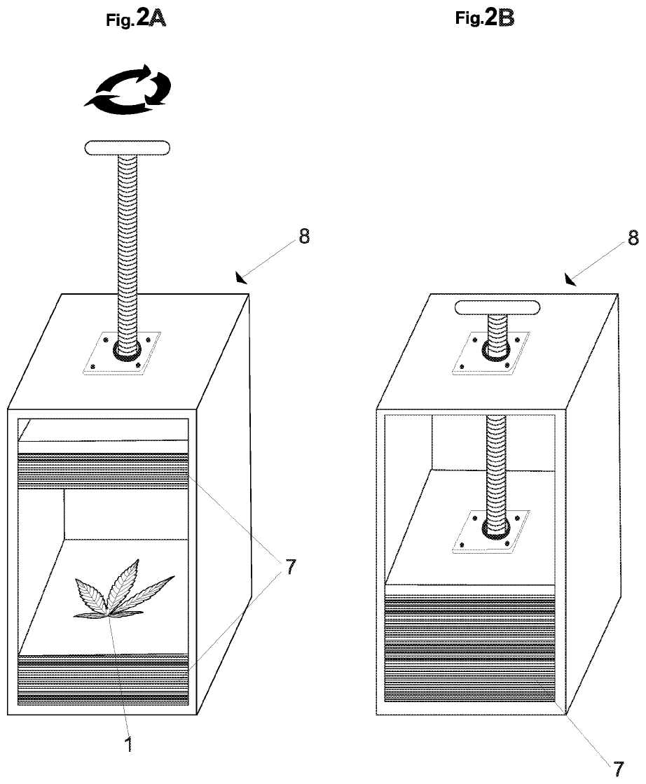

FIG. 3—shows Phase 5 “Vacuum coating and sealing with waterproofing and protective film”, in which the Leaf (1) is placed between two layers of adhesive film, placing the adhesive side (9b-10b) to contact with Leaf surface and side lined with liner (9a-10a) towards the outside.

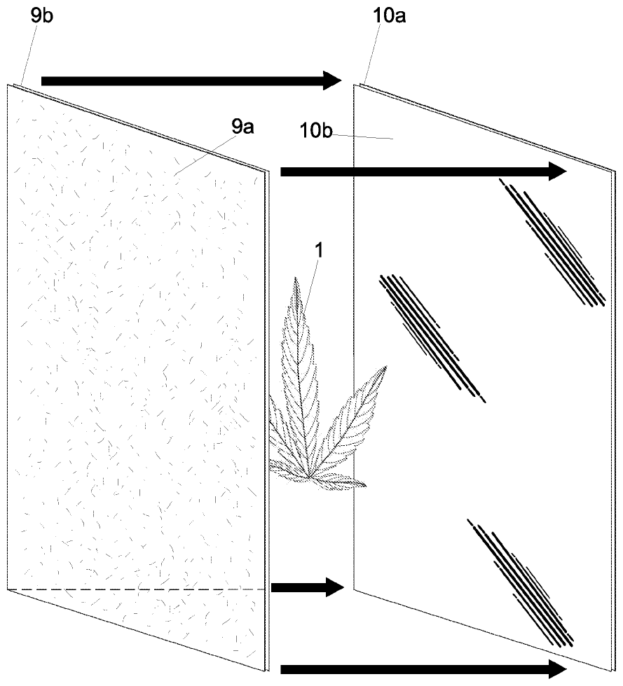

FIG. 4—shows Phase 5 “Vacuum coating and sealing with waterproofing and protective film”. The figure is composed of two images: image 4A shows hot-pressing (2) and roller passage (11a) which occurs immediately after pressing; image 4B shows the use of a cold rolling machine (11b) as an alternative the use of the rubber roller.

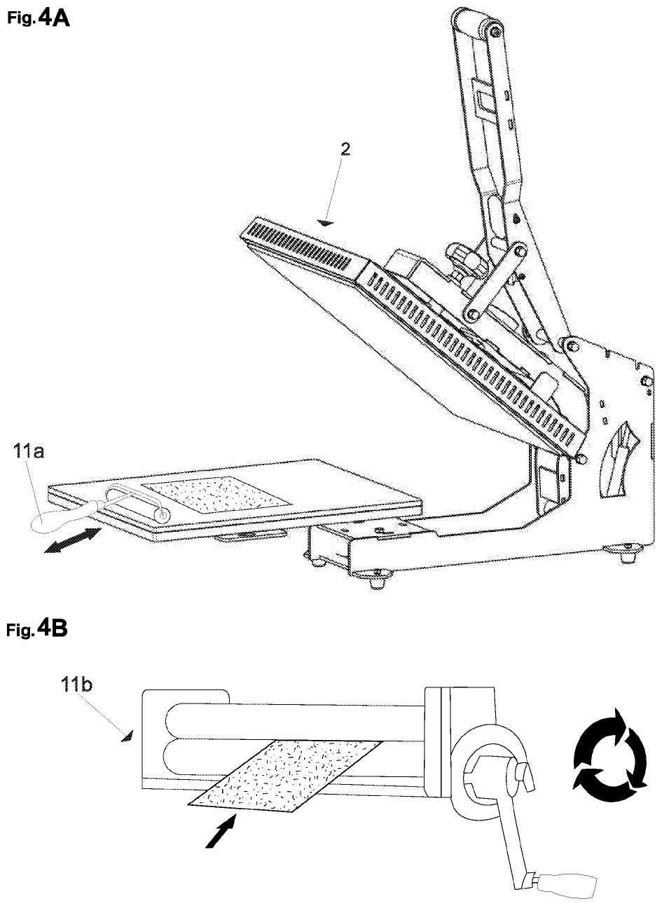

FIG. 5—shows Phase 6 “Application on the surface of the article to be decorated”. FIG. 5 is composed of two images: the image 5A shows the removal of the film liner (10a) adhesive on the underside of the Leaf; the image 5B shows the application of a layer of adhesive in thermo-adhesive film format (12), the which is adhered to on the underside from which we removed the liner, repeating the operations of hot pressing and roller passage referred to in FIG. 4.

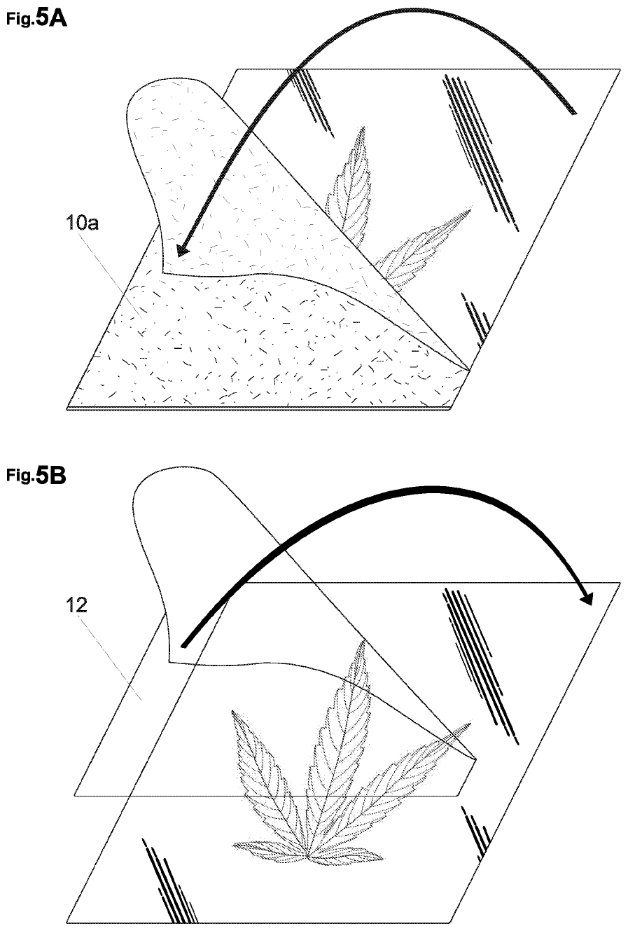

FIG. 6—shows Phase 6 “Application on surface of article to decorate”. The image shows the removal, using scissors, of the excess part of the heat-adhesive film incorporating the Leaf (1), maintaining the coating of a few millimetres protruding around to the perimeter of it.

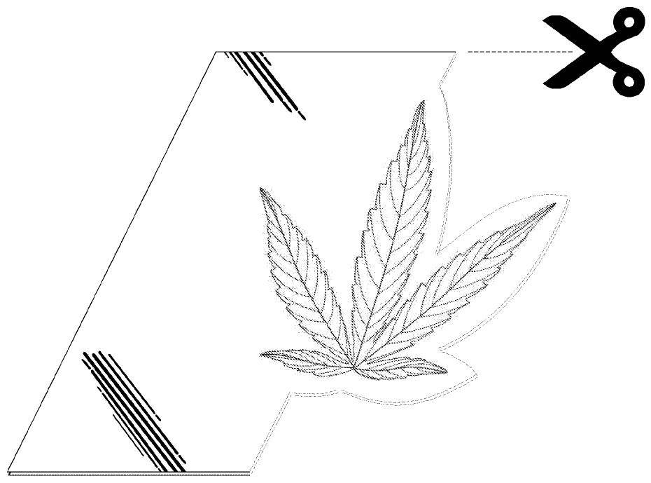

FIG. 7—shows Phase 6 “Application on the surface of the article to be decorated”. The image shows the application of the coated Leaf on the surface of the article to be decorated which in the figure is represented by a t-shirt (13), using the hot press, and shows the removal of the liner (9a) immediately after the pressing.

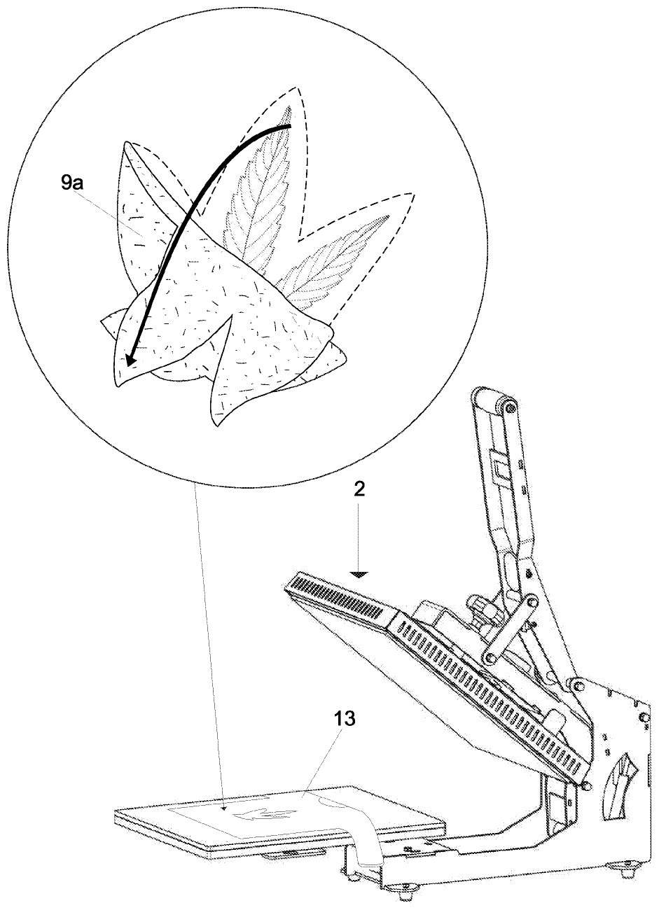

FIG. 8 shows Phase 6 “Application on the surface of the article to be decorated”. The image shows the application of the coated Leaf on the surface of the t-shirt (13) by a seam made along the perimeter of the lining having already removed both liners (9a-10a).

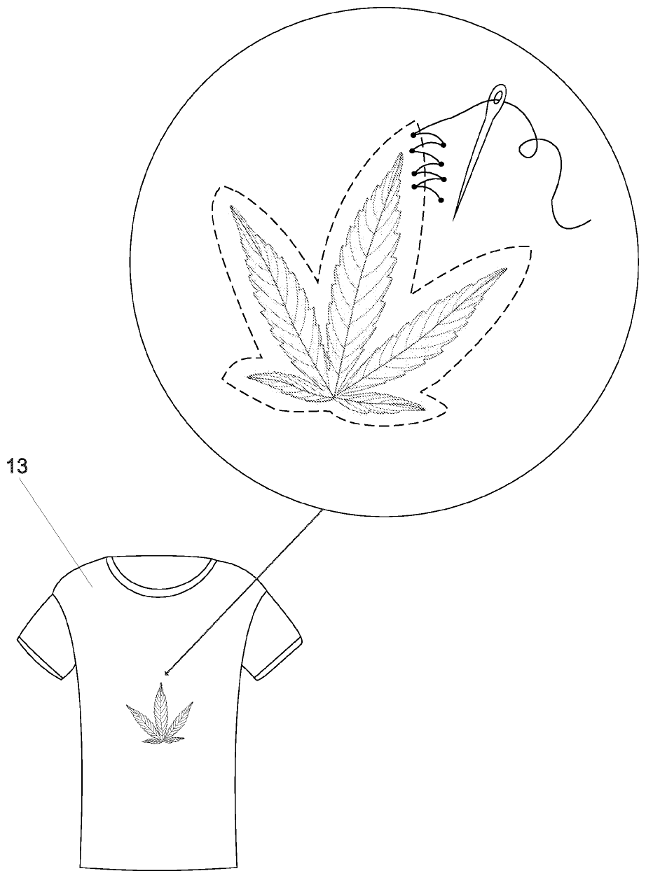

1. A method for the realization of a vegetable component with a protective, waterproofing and washable coating, suitable to be applied on the surface of an article to be decorated, which consists of the following phases:
phase 1—Harvesting of the vegetable component; phase 2—Cleaning of the plant component by air jet and/or scrubbing with a damp cloth; phase 3—Drying and ironing: the clean vegetable component is interposed between layers of absorbing material and pressed between heated plates, for example inside a hot press (2) whose top plate (3) is covered with a sheet of paper (4) and bottom plate (5) from a felt cloth (6); phase 4—Stabilising and conservating pressing: the vegetable component is interposed between layers of material with a smooth and absorbent surface, for example sheets of paper (7), exerting pressure on them (8); phase 5—Vacuum coating and sealing with a sealing and protective film: the dehydrated vegetable component is interposed between two layers of film made of impermeable and non-breathable plastic material, for example between two layers of thermo-adhesive polyurethane film, positioned with the liner (9a-10a) towards the outside and with the thermo-adhesive side (9b-10b) towards the inner side in contact with the vegetable component (1) and pressed inside a hot press (2) and then by a rubber roller (11a) manually passed on both sides, or also by a cold-rolling machine (11b).

2. A method according to claim 1 that allows a vegetable component to be subjected to stress caused by washing also in the washing machine, by bending, by friction with other bodies and by stress of compression, traction and/or torsion, without decomposing, leaving unchanged the colouration of the vegetable component and therefore suitable for repeated use.

3. A method according to claim 1 which also allows the application of the plant component on the surface of an article to be decorated by the following step: phase 6—Application on the surface of the article to be decorated: the waterproofed vegetable component is then applied to the surface of the article to be decorated, for example a t-shirt (13), by means of a glue, for example a thermo-adhesive film (12) which is made to adhere to the film (10a-10b) placed on the underside of the plant component by hot pressing after removing the liner (10a); then, after removing the excess of the coating, the whole material is applied to the surface of the t-shirt (13) by hot pressing and the liner is removed (9a); together with or as an alternative to using the adhesive (12) a perimeter seam is made at the edges of the coating of the plan component after removing both liners (9a-10a).

4. A vegetable component, such as a leaf of hemp (1), with a protective, waterproofing and washable coating consisting of a plastic polymeric film, such as a thermo-adhesive polyurethane film, obtained by the procedure referred to in the preceding claims.

5. A vegetable component according to claim 4 consisting of a leaf of hemp (1) or a leaf of any plant, a flower, a petal, the exocarp of a fruit, therefore any whole plant component or part of it.

6. A vegetable component, according to all previous claims, applied for decorative purposes on the fabric of a t-shirt (13) or on any type of fabric, animal or vegetable skin, skin-like, non-woven fabric, fabric composed of natural fibres and/or chemical fibres and on any object, such as clothing, fashion accessories, furnishing components, everyday household and industrial articles.
